(19) United States
(12) Patent Application Publication
(10) Pub. No.: US 2022/0192443 A1
(43) Pub. Date: Jun. 23, 2022

(54) WATERLESS TOILET

(71) Applicant: CLOSAC AG, Grabs (CH)

(72) Inventors: Julien FURSTOS, Bartenheim (FR); Sebastian OEHL, Zürich (CH)

(21) Appl. No.: 17/594,395

(22) PCT Filed: May 15, 2020
(86) PCT No.: PCT/EP2020/063703

§ 371 Date: Oct. 14, 2021

(30) Foreign Application Priority Data
May 17, 2019 (DE) 10 2019 113 141.3

(51) Int. Cl. A47K 11/02; G06K 7/14; G06K 7/12

(52) U.S. Cl. CPC A47K 11/026; G06K 7/12; G06K 7/1417

(57) ABSTRACT

A waterless toilet (1), at least comprising a tubular film (2), a transport unit for transporting the tubular film and a detection device (3) for detecting the tubular film (2), wherein the tubular film (2) has, over its entire length, a pattern (7) that can be detected by the detection device (3).

### CROSS-REFERENCES TO RELATED APPLICATIONS

This application is a Section 371 National Stage Application of International Application No. PCT/EP2020/063703, filed May 15, 2020, and published as WO 2020/234187 A1 on Nov. 26, 2020, and claims priority to German Application No. 102019113141.3, filed May 17, 2019, the contents of both are hereby incorporated by reference in their entirety.

### BRIEF DESCRIPTION OF THE DRAWINGS

FIG. 1: shows a simplified sectional representation of a detail of a waterless toilet according to the invention;

FIG. 2: shows a representation of the tubular film with a detection device of the waterless toilet of FIG. 1.

### DETAILED DESCRIPTION OF THE DRAWINGS

The invention relates to a waterless toilet according to the preamble of claim 1.

Waterless toilets are already known from the prior art. These are inter alia toilets in which there is a tubular film, or a corresponding container, for collecting fecal matter. To this end, the tubular films filled with fecal matter are generally welded into sections after filling so that they can subsequently be disposed of properly.

A problem with known waterless toilets is sometimes that the amount of tubular film available is not monitored, so that manual monitoring or premature replacement in order to ensure operating readiness takes place. A further disadvantage is that tubular films that do not interact optimally with the toilet may be used, which may for example be reflected in the quality of the welding.

The object of the invention is therefore to provide a waterless toilet that can be operated with tubular films, for which it is possible to achieve optimal operation of the waterless toilet, in particular an optimal welding outcome of the tubular films.

The invention is based on a waterless toilet. The waterless toilet comprises at least a tubular film, a transport unit for transporting the tubular film and a detection device for detecting the tubular film, wherein the tubular film has, over its entire length, a pattern that can be detected by the detection device.

The detectable pattern allows detection, or identifying detection, of the tubular film for the waterless toilet. In this way, detection and allocation of a particular tubular film, or of a tubular film composition, to the waterless toilet may be carried out. This can have a positive effect on the welding outcome when welding the tubular film and therefore also a positive effect on the operating reliability of the waterless toilet.

One possible detection device is in this case provided by an optoelectronic sensor unit, in particular a photoelectric barrier, a contrast sensor or the like, which can alternately be interrupted and enabled by the pattern. Other types of such pattern detections, in particular photoelectric barriers and contrast sensors in the visible and invisible spectra, may also be envisioned.

In one advantageous refinement of the invention, the pattern may comprise pattern sections, preferably pattern sections having a defined data content, in particular for indication of the starting region and/or central region and/or end region.

Identification of the various regions along the length of a tubular film ensures that the user is informed about tubular film still sufficiently available, and in particular the need for a tubular film replacement may be signaled. In addition, further information relating to the tubular film may be obtained by means of the data content, for example its length of use in order to detect material aging, or its manufacturing date or the like.

In one refinement of the invention, the pattern may be configured as a periodic pattern at least partially, preferably continuously, or between a starting region and/or a central region and/or an end region of the tubular film.

The use of a periodic pattern allows a simple counting procedure, which constitutes a simple and reproducible means for monitoring the transport of the tubular film and obtaining information relating to the transport distance carried out. No particular computing power or evaluation power is required for the counting process in this case, so that it may be carried out reliably with economical component parts.

In the case of arranging information sections respectively at the start, the middle and at the end, the periodic counting pattern is optionally formed only between these regions.

In terms of production technology, it may be advantageous to print the periodic pattern continuously as a whole and, after definition of the tubular film and separation to a desired length, to arrange a data segment at the starting region and/or a central region and/or an end region, in addition to the periodic pattern. For reasons of cost, for example, one or more of these regions may in this case also be omitted, for example if only a film end is intended to be detected.

In one refinement of the invention, the periodic pattern may comprise at least two pattern components that differ particularly in length of the pattern components and/or information content of the pattern components.

By different pattern components, information relating to the position of the pattern along the tubular film may be provided, and this may in turn be detected and counted simply. Such pattern components may for example be QR codes, a code having information segments or a barcode section or the like.

This allows detection of the correct tubular film for the specific toilet, detection of the production run (production batch) or data of this type, as well as detection of the forward feed, the forward feed rate and the position along the tubular film.

In one refinement of the invention, the pattern may comprise encoding. In this way, for example, it is possible to check whether a certified tubular film, which can interact optimally with the waterless toilet, is being used. This is, in particular, of particular relevance if the tubular film is, for example, intended to be welded process-reliably by means of a welding apparatus during operation, as disclosed for example by DE 10 2017 108 556 A1.

In one refinement of the invention, the pattern may furthermore be configured as an optoelectronically readable, in particular IR-readable, marking.

Such a marking may be applied simply onto the tubular film, and may correspondingly be evaluated simply if the tubular film is configured to be nontransparent for visible light, which is often desirable in the field of collecting fecal matter.

In one refinement of the invention, the pattern (7) may furthermore at least partially comprise a code having information segments, particularly in the form of an optoelectronically readable code. This can allow rapid electronic evaluation of the information. Information segments in this case may, but need not, be arranged over the entire length. It is also conceivable to encode the information segments in the form of an ID and to query specific data relating to the tubular film via an interface with a database, for example via the Internet. Such information segments may for example be QR codes, a code having data content or a barcode section, or the like.

A method for controlling a waterless toilet according to one of the embodiments above is furthermore proposed, wherein the pattern is used as a key for function enablement for the toilet. In this way, a unique allocation may be carried out between the tubular film and the toilet, and malfunctions when processing the tubular film are avoided. This increases the process reliability when operating such a toilet.

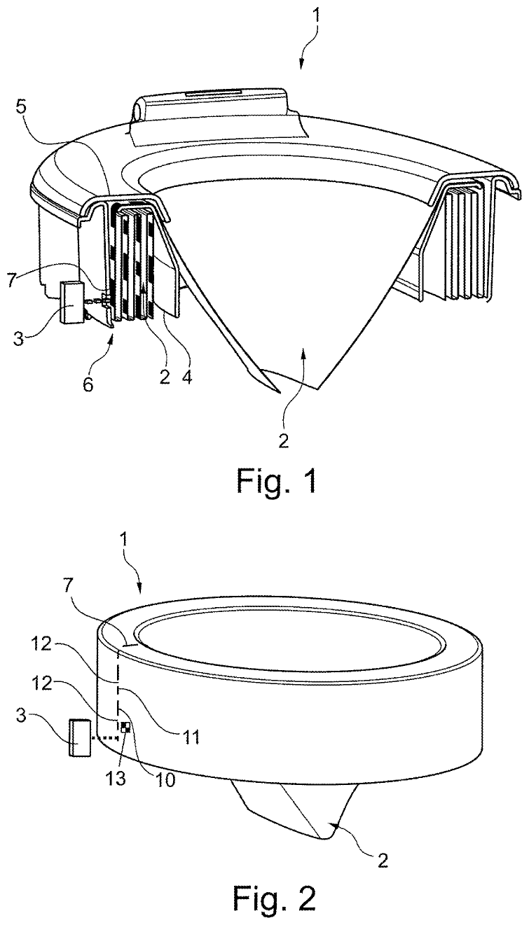

FIGS. 1 and 2 schematically show a part of a seat unit of a waterless toilet 1 according to the invention, or of the tubular film with a detection device. For reasons of simplified representation, only a detail of the toilet is represented in this case.

The waterless toilet 1 comprises a tubular film 2. The tubular film is stored in a reception region 4 in the seat 5 of the toilet, and is fed out upward from this reception region 4 at an edge. In the present exemplary embodiment, the tubular film is in the form of a meandering film package stacked in layers, the layer fed upward being arranged on the radially outer-lying end 6 of the stack.

A transport unit (not shown in detail) for transporting the tubular film 2, which may for example be configured as a transport roller pair below the seat arrangement, is furthermore included.

The waterless toilet 1 furthermore comprises a detection device 3 for detecting the tubular film 2. This is configured in the present case as a contrast sensor or photoelectric barrier. According to the invention, the tubular film 2 in this case has over its length a pattern 7 that can be detected by the detection device 3. In the exemplary embodiment shown (see in particular FIG. 2), the pattern 7 is configured as a periodic pattern. The pattern in this case comprises a long section 10 and a short section 11, as well as constant intermediate sections 12. The detection device is therefore capable of counting the material sections and, by detecting the pattern sequences per se, also of identifying the sort of tubular film being used. In particular, the identification may for example be improved by the short pattern section being applied not as an area but as an information carrier, for example in the form of a QR code (13). This may in turn, for example, contain information relating to the production date and the type of material, and may therefore optimally control the welding unit of the toilet.

The QR code (13) may in this case be formed as the pattern section itself or in addition to the periodic pattern, as represented in the present case. A corresponding arrangement at the starting region, the middle or the end region of the tubular film is also expedient in the manner described.

Although the present invention has been described with reference to preferred embodiments, workers skilled in the art will recognize that changes may be made in form and detail without departing from the spirit and scope of the invention.

### LIST OF REFERENCES

1 waterless toilet
2 tubular film
3 detection device
4 reception region
5 seat
6 outer-lying end
7 pattern
10 short section
11 long section
12 intermediate section
13 QR code

1. A waterless toilet comprising:
a tubular film;
a transport unit for transporting the tubular film; and
a detection device comprising a photoelectric barrier or a contrast sensor, for detecting the tubular film, wherein the tubular film comprises, over its entire length, a pattern that can be detected by the detection device.

2. The waterless toilet of claim 1, wherein the pattern comprises pattern sections, preferably pattern sections having a defined data content, in particular for indication of the starting region and/or central region and/or end region of the tubular film.

3. The waterless toilet of claim 2, wherein the pattern is configured as a periodic pattern at least partially, preferably continuously, or between a starting region and/or a central region and/or an end region of the tubular film.

4. The waterless toilet of claim 3, wherein the periodic pattern comprises at least two pattern components that differ particularly in length and/or information.

5. The waterless toilet of claim 4, wherein besides the periodic pattern, an additional pattern section having a data content defined for this region is respectively arranged in a starting region and/or a central region and/or an end region of the tubular film.

6. The waterless toilet of claim 1, wherein the pattern comprises encoding for identification of the tubular film.

7. The waterless toilet of claim 1, wherein the pattern is configured as an optoelectronically readable, in particular IR-readable, marking.

8. The waterless toilet of claim 1, wherein the pattern at least partially comprises a code having information segments, particularly in the form of an optoelectronically readable code.

9. A method for controlling a waterless toilet comprising,
detecting a pattern on a tubular film of the waterless toilet;
controlling the toilet based on the pattern.

10. A tubular film for use in a waterless toilet comprising a detectable pattern.
